(19) United States
(12) Patent Application Publication
(10) Pub. No.: US 2017/0116557 A1
(43) Pub. Date: Apr. 27, 2017

(54) SYSTEM AND METHOD FOR PERFORMING ROOT CAUSE ANALYSIS ON UNSTRUCTURED DATA

(71) Applicant: Tata Consultancy Services Limited, Mumbai (IN)

(72) Inventors: Manoj Madhav APTE, Pune (IN); Sachin Sharad PAWAR, Pune (IN); Girish Keshav PALSHIKAR, Pune (IN); Sriram BASKARAN, Pune (IN); Amol Madhukar AAEER, Pune (IN)

(73) Assignee: Tata Consultancy Services Limited, Mumbai (IN)

(21) Appl. No.: 15/299,069

(22) Filed: Oct. 20, 2016

(30) Foreign Application Priority Data
Oct. 21, 2015 (IN) 3979/MUM/2015

(51) Int. Cl. G06Q 10/06; G06F 17/27; G06F 17/21; G06F 17/30

(52) U.S. Cl. CPC G06Q 10/06398; G06F 17/30684; G06F 17/2785; G06F 17/218; G06F 2216/03

(57) ABSTRACT

The present disclosure relates to methods, systems, and computer-readable media for performing root cause analysis on unstructured data to identify root causes of poor performance of an employee and to recommend one or more actions based on root causes and suggestions identified from unstructured data. Embodiments of the present disclosure may determine the presence of root causes using pattern matching, sentiment analysis and suggestion identification in the one or more employee comments and supervisor comments and further recommend actions based on suggestions from the one or more supervisor comments and the root causes of poor performance identified.

### PRIORITY CLAIM

This U.S. patent application claims priority under 35 U.S.C. §119 to Indian Patent Application No. 3979/MUM/2015, filed on Oct. 21, 2015, the entirety of which is hereby incorporated by reference.

### TECHNICAL FIELD

The embodiments herein generally relates to information mining and more particularly, to automated identification of root causes of poor performance of employees and suggestion for improving performance of the employees using information mining on unstructured data.

### BACKGROUND

Historically, organizations employ performance analysis systems to assess employees' performance and productivity. Performance analysis of the employees is useful in identifying root causes of poor performance of the employees and in enabling a Human Resource department to take appropriate and timely actions in order to improve the performance of underperforming employees. Such actions are required to reduce the impact of any systemic problems existing in the organization. Organizations also carry out appraisals of the employees based on the results of analysis of the employees' performance. One of the most widely used methods for reviewing performance of an employee is Goals based performance measurement.

Generally, analyzing root cause for poor employee performance and suggestion mining for the employee is performed by manual analysis on the performance appraisal data. The performance appraisal data may include employee self-comments, corresponding opinions and suggestions given by supervisors to the employee that provide valuable input for carrying out evaluation. The suggestions and comments given by the employee and their supervisors which are reviewed by the human resource department for opinion mining are generally in the form of free text. In a large organization with a large no. of employees working in various projects and teams, the comments and opinions for employees' performance are mostly varied and unstructured. Analyzing such large volume of unstructured content to identify meaningful content that conveys value without any information loss can be extremely time consuming and challenging. Further, such data may be analyzed with a sentiment analysis technique in order to extract more relevant information about corresponding root causes as well as the suggestions. Further, usually the format of suggestions given by the supervisors differs with personal behavior of each individual and hence cannot be accurately found by a general suggestion identifier.

Currently, there exists many challenges in analysis of the unstructured performance appraisal data for assessing performance of individual employees. Further, the current techniques fail in detecting the existence of and identifying a set of probable root causes for poor performance of the employees, but also in recommending relevant actions to be taken based on the summarized performance appraisal data.

### SUMMARY

Before the present systems and methods, are described, it is to be understood that this disclosure is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and methods for identification of root causes of poor performance and suggestion for improved performance of employees, and the concepts are further described below in the detailed description. This summary is not intended to identify essential features of the disclosure nor is it intended for use in determining or limiting the scope of the disclosure.

Embodiments of the present disclosure represent the technological improvements as solutions to one or more of the above-mentioned technical problems recognized by the inventors n conventional systems. For example, in one implementation, a system for automated root cause identification for poor performance of an employee is disclosed. In one aspect, the system comprises a processor and a memory coupled to the processor. The processor executes a plurality of modules present in the memory. The plurality of modules comprise a receiving module 212, a root cause mining module 214 and a suggestion analysis module 216. The receiving module is configured to receive one or more employee comments for self-performance, one or more supervisor comments for the performance of the employee and root cause pattern data. The root cause mining module may be configured to identify a root cause for the poor performance of an employee from the one or more employee comments. The root cause mining module is configured to match at least one pattern from the root cause pattern data with the one or more employee comments to obtain a first matched pattern within the employee comments to determine whether the one or more employee comments include a self-admission or a reason for the poor performance of the employee, to signify presence of a root cause in the one or more employee comments, wherein the at least one pattern is a regular expression based pattern and when the one or more employee comments is not including the self-admission or a reason, the root cause mining module is configured to determine presence of one of a negative pattern type in the first matched pattern and a negative word near the first matched pattern present in the one or more employee comments to signify presence of the root cause in the one or ore employee comments. The root cause module further determines presence of a negative word in the one or more supervisor comments. In one embodiment, the root cause mining module is configured to determine that when no pattern from the root cause pattern data matches with the one or more employee comments, it signifies that no root cause is present in the one or more employee comments. The root cause mining module is further configured to determine that the presence of each of the negative pattern type in the first matched pattern, the negative word in the one or more employee comments near the first matched pattern, and the negative word in the one or more supervisor comments signifies the presence of the root cause in the one or more employee comments. The root cause mining module is further configured to determine that the absence of both the negative pattern type in the first matched pattern and the negative word near the first matched pattern in the one or more employee comments and the presence of negative word in the one or more supervisor comments signifies the presence of the root cause in the one or more employee comments. In one embodiment, the root cause mining module is configured to further determine that the presence of both the negative pattern type in the first matched pattern and the negative word near the first matched pattern in the one or more employee comments and the absence of the negative word in the one or more supervisor comments, signifies that no root cause is present in the one or more employee comments. In one embodiment, the root cause mining module is configured to determine that the absence of each of the negative pattern type in the first matched pattern, the negative word near the first matched pattern in the one or more employee comments and the negative word in the supervisor comments signifies that no root cause is present in the one or more employee comments.

The root cause mining module is further configured to identify a root cause for the poor performance of an employee from the one or more supervisor comments by matching at least one pattern from the root cause pattern data with the one or more supervisor comments to obtain a second matched pattern to determine whether the one or more supervisor comments within the supervisor comments include at least one suggestion, to signify presence of the root cause in the one or more supervisor comments, wherein the at least one pattern is a regular expression based pattern and when the one or more supervisor comments is not including the at least one suggestion, determine presence of one of the negative pattern type in the second matched pattern and the negative word near the second matched pattern in the one or more supervisor comments, to signify presence of the root cause in the one or more supervisor comments. The root cause module is configured to determine that when no pattern from the root cause pattern data matches with the one or more supervisor comments signifies that no root cause is present in the one or more supervisor comments. The root cause module includes a suggestion analysis module 216 which may be configured to determine the at least one suggestion from the one or more supervisor comments by matching a first text pattern with a plain text sentence of the one or more supervisor comments, wherein the first text pattern match identifies words or bigrams indicating the at least one suggestion present in the one or more supervisor comments, and matching a second POS tagged text pattern with a POS-tagged sentence in the one or more supervisor comments, wherein the second POS tagged text pattern matches identifies at least one of a combination of one or more words along with one or more POS tags indicating at least one suggestion and imperative sentences; and recommend one or more actions based on the root causes so identified and the at least one suggestion determined from the one or more supervisor comments. The root cause mining module is configured to determine that either the presence of both the negative pattern type in the second matched pattern and the negative word in the one or more supervisor comments or the absence of both the negative pattern type in the second matched pattern and the negative word in the one or more supervisor comments, signifies that no root cause is present in the one or more supervisor comments.

In another implementation, a method for automated root cause identification for poor performance of an employee is disclosed. In order to facilitate the identification of root causes of poor performance, initially, one or more employee comments for self-performance, one or more supervisors comments for the performance of the employee and root cause pattern data are received. The method further comprises identifying a root cause for the poor performance of an employee from the one or more employee comments by matching at least one pattern from the root cause pattern data with the one or more employee comments to obtain a first matched pattern within the employee comment to determine whether the one or more employee comments include a self-admission or a reason for the poor performance of the employee, to signify presence of the root cause in the one or more employee comments, and when the one or more employee comments is not including the self-admission or the reason, the method further comprises determining presence of one of a negative pattern type in the first matched pattern or a negative word in the one or more employee comments near the first matched pattern present in the one or more employee comments to signify presence of the root cause in the one or more employee comments. The method further comprises determining the presence of a negative word in the one or more supervisor comments. The method further comprises determining that when no pattern from the root cause pattern data matches with the one or more employee comments signifies that no root cause is present in the one or more employee comments. The method further comprises determining that the presence of each of the negative pattern type in the first matched pattern, the negative word in the employee comments near the first matched pattern, and the negative word in the one or more supervisor comments signifies the presence of the root cause in the one or more employee comments. Further, the method comprises determining that the absence of both the negative pattern type in the first matched pattern and the negative word in the one or more employee comments near the first matched pattern and the presence of negative word in the supervisor comments, signifies that a root cause is present in the one or more employee comments. The method further comprises determining that the presence of both the negative type in the first matched pattern and the negative word near the first matched pattern in the one or more employee comments and the absence of the negative word in the one or more supervisor comments, signifies that no root cause is present in the one or more employee comments. The method may determine that the absence of each of the negative pattern type in the first matched pattern, the negative word near the first matched pattern in the one or more employee comments and the negative word in the supervisor comments signifies that no root cause is present in the one or more employee comments.

The method further comprises identifying a root cause for the poor performance of an employee from the one or more supervisor comments by matching at least one pattern from the root cause pattern data with the one or more supervisor comments to obtain a second matched pattern to determine whether the one or more supervisor comments within the supervisor comments include at least one suggestion, to signify presence of the root cause in the one or more supervisor comments, and when the supervisor comment is not including the at least one suggestion, determining presence of one of the negative pattern type in the second matched pattern and the negative word near the second matched pattern in the one or more supervisor comments, to signify presence of the root cause in the one or more supervisor comments. The method further comprises determining the at least one suggestion from the one or more supervisor comments by matching a first text pattern with a plain text sentence of the one or more supervisor comments, wherein the first text pattern match identifies words or bigrams indicating the at least one suggestion present in the one or more supervisor comments, and matching a second POS tagged text pattern with a POS-tagged sentence in the one or more supervisor comments, wherein the second POS tagged text pattern match identifies at least one of a combination of one or more words along with one or more POS tags indicating the at least one suggestion and imperative sentences; and further recommending one or more actions based on the root causes so identified and the at least one suggestion determined from the one or more supervisor comments. The method further comprises determining that either the presence of both the negative pattern type in the second matched pattern and the negative word in the one or more supervisor comments or the absence of both the negative pattern type in the second matched pattern and the negative word in the one or more supervisor comments, signifies that no root cause is present in the one or more supervisor comments.

In yet another implementation, a non-transitory computer program product having embodied thereon a program executable in a computing device for executing a method for implementing automated root cause identification for poor performance of an employee is disclosed. The program comprises a program code for receiving one or more employee comments for self-performance, one or more supervisor comments for the performance of the employee and root cause pattern data. The program further comprises a program code for identifying a root cause for poor performance of the employee from the one or more employee comments by matching at least one pattern from the root cause pattern data with the one or more employee comments to obtain a first matched pattern within the employee comment to determine whether the one or more employee comments include a self-admission or a reason for the poor performance of the employee, to signify presence of a root cause in the one or more employee comments, and when the employee comment is not including the self-admission or the reason, the program comprises program code for determining presence of a negative pattern type in the first matched pattern or a negative word near the first matched pattern in the one or more employee comments to signify presence of the root cause in the one or more employee comments. The program further comprises a program code for determining the presence of a negative word in the one or more supervisor comments. The program further comprises a program code for determining that when no pattern from the root cause pattern data matches with the one or more employee comments signifies that no root cause is present in the one or more employee comments. The program further comprises a program code that the presence of each of the negative type in the first matched pattern, the negative word in the employee comments near the first matched pattern, and the negative word in the one or more supervisor comments signifies the presence of the root cause in the one or more employee comments. The program code may determine that the absence of both the negative type in the first matched pattern and the negative word in the one or more employee comments near the first matched pattern and the presence of negative word in the supervisor comments, signifies that a root cause is present in the one or more employee comments. The program code may determine that the presence of both the negative type in the first matched pattern and the negative word in the one or more employee comments near the first matched pattern and the absence of the negative word in the one or more supervisor comments, signifies that no root cause is present in the one or more employee comments. The program code may determine that the absence of each of the negative type in the first matched pattern, the negative word in the one or more employee comments near the first matched pattern and the negative word in the supervisor comments signifies that no root cause is present in the one or more employee comments.

The program further comprises a program code for identifying a root cause for the poor performance of an employee from the one or more supervisor comments by matching at least one pattern from the root cause pattern data with the one or more supervisor comments to obtain a second matched pattern to determine whether the one or more supervisor comments include at least one suggestion, to further presence of the root cause in the one or more supervisor comments, and when the supervisor comment is not including the at least one suggestion, determining presence of one of the negative pattern type in the second matched pattern and the negative word near the second matched pattern in the one or more supervisor comments, to signify presence of the root cause in the one or more supervisor comments. The program further comprises program code for determining the at least one suggestion from the one or more supervisor comments by matching a first text pattern with a plain text sentence of the one or more supervisor comments, wherein the first text pattern identifies words or bigrams indicating the at least one suggestion present in the one or more supervisor comments, and matching a second POS tagged text pattern with a POS-tagged sentence in the one or more supervisor comments, wherein the second POS tagged text pattern matches identifies at least one of a combination of one or more words along with one or more POS tags indicating the at least one suggestion and imperative sentences; and recommending one or more actions based on the root causes so identified and the at least one suggestion determined from the one or more supervisor comments. The program further comprises program code for determining that either the presence of both the negative pattern type in the second matched pattern and the negative word in the one or more supervisor comments or the absence of both the negative pattern type in the second matched pattern and the negative word in the one or more supervisor comments, signifies that no root cause is present in the one or more supervisor comments.

### BRIEF DESCRIPTION OF THE DRAWINGS

The foregoing summary, as well as the following detailed description of preferred embodiments, are better understood when read in conjunction with the appended drawing. For the purpose of illustrating the invention, there is shown in the drawing an exemplary construction of the invention, however, the invention is not limited to the specific methods and system illustrated.

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for identification of root causes of poor performance of an employee is shown, in accordance with an embodiment of the present disclosure.

FIG. 2 illustrates the system for identification of root causes of poor performance of an employee in accordance with an exemplary embodiment of the present subject matter.

FIG. 3 illustrates analysis of employee comments to signify the presence of root causes of poor performance of an employee in accordance with an embodiment of the present subject matter.

FIG. 4 illustrates analysis of supervisor comments to signify the presence of root causes of poor performance of an employee in accordance with an embodiment of the present subject matter.

FIG. 5 illustrates a method for identification of root causes of poor performance of an employee, in accordance with an embodiment of the present subject matter.

### DETAILED DESCRIPTION

The embodiments herein and the various features and advantageous details thereof are explained more fully with reference to the non-limiting embodiments that are illustrated in the accompanying drawings and detailed in the following description. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Some embodiments of this disclosure, illustrating all its features, will now be discussed in detail. The disclosed embodiments are merely exemplary of the disclosure, which may be embodied in various forms.

Before setting forth the detailed explanation, it is noted that all of the discussion below, regardless of the particular implementation being described, is exemplary in nature, rather than limiting.

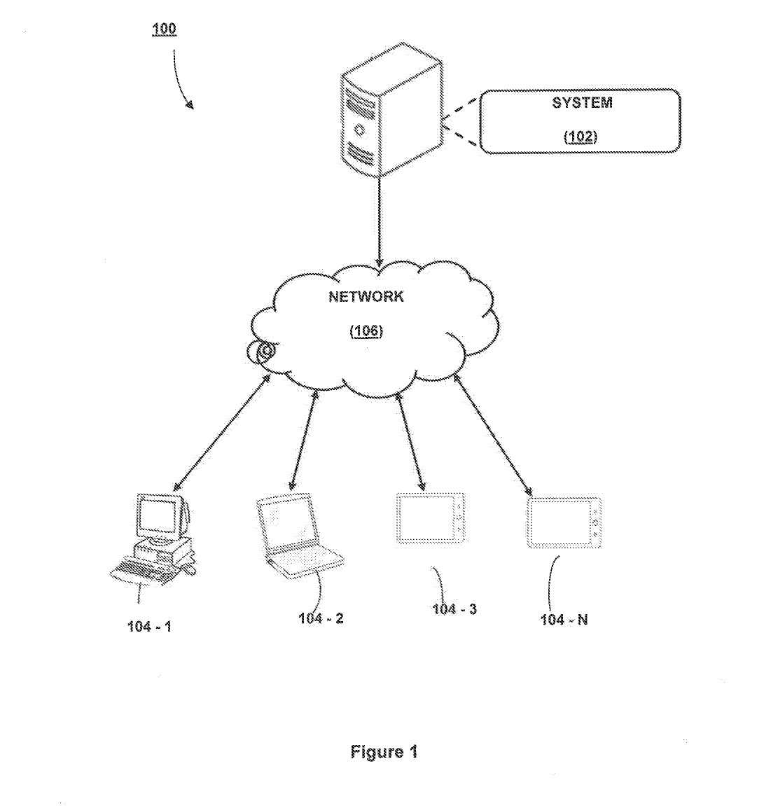

Referring now to the drawings, and more particularly to FIG. 1 through 5, where similar reference characters denote corresponding features consistently throughout the figures, there are shown preferred embodiments and these embodiments are described in the context of the following exemplary systems and/or methods.

Referring to FIG. 1, a network implementation 100 of a system, hereinafter referred to as a system 102, for facilitating automated root cause identification for poor performance of an employee is disclosed, in accordance with an embodiment of the present subject matter. In one embodiment, the system 102 initially, receives comments of one or more employees about the performances, one or more comments from one or more supervisors about the performance of the one or more employees and root cause pattern data. The system 102 may further determine the presence of a root cause in the one or more employee comments and one or more supervisor comments by matching the one or more employee comments and one or more supervisor comments with pre-defined regular expression based patterns and determining the sentiment of the one or more employee comments and one or more supervisor comments. The system 102 to determine one or more root causes includes determining one or more suggestions from one or more supervisor comments using a plain text pattern and/or a POS tagged text pattern. The system 102 may further recommend one or more actions based on the above identified root causes and the suggestions identified from the one or more supervisor comments.

Although the present disclosure is explained considering that the system 102 is implemented on a server, it may be understood that the system 102 may also be implemented in a variety of computing systems, such as a laptop computer, a desktop computer, a notebook, a workstation, a mainframe computer, a server, a network server, a cloud-based computing environment. It will be understood that the system 102 may be accessed by multiple users through one or more user devices 104-1, 104-2 . . . 104-N, collectively referred to as user 104 hereinafter, or applications residing on the user devices 104. In one implementation, the system 102 may comprise the cloud-based computing environment in which a user may operate individual computing systems configured to execute remotely located applications. Examples of the user devices 104 may include, but are not limited to, a portable computer, a personal digital assistant, a handheld device, and a workstation. The user devices 104 are communicatively coupled to the system 102 through a network 106. Examples of a user may include, but not limited to, a Human resource executive of an organization, a supervisor, an administrative personnel and the like.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

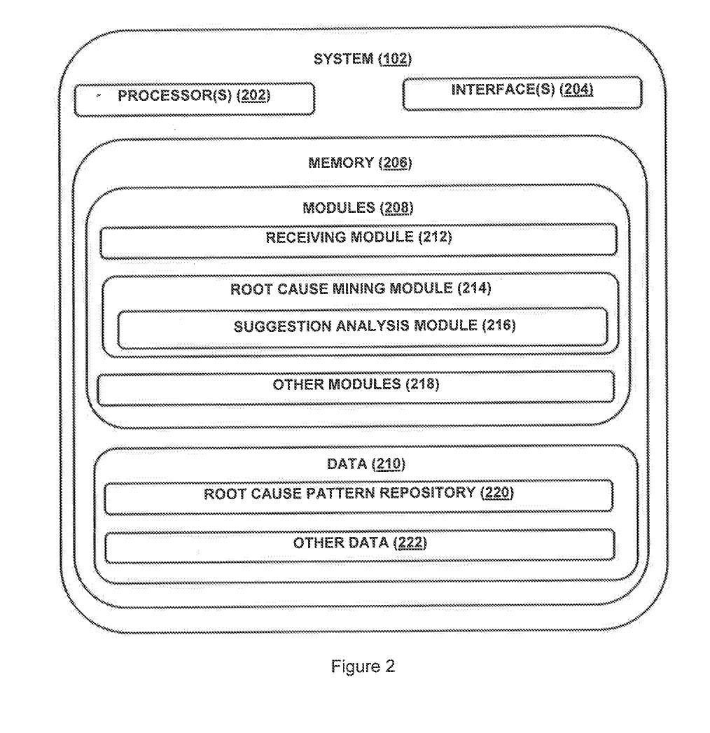

Referring now to FIG. 2, the system 102 for automated root cause identification for poor performance of an employee is illustrated in accordance with an embodiment of the present disclosure. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium and computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a receiving module 212, a root cause mining module 214, an analyzing module 216 and other modules 222. The other modules 218 may include programs or coded instructions that supplement applications and functions of the system 102. The modules 208 described herein may be implemented as software modules that may be executed in the cloud-based computing environment of the system 102.

The data 210, amongst other things, serves as a repository for storing data processed, received, and generated by one or more of the modules 208. The data 210 may also include a root cause pattern repository 220 and other data 222. The other data 222 may include data generated as a result of the execution of one or more modules in the other modules 218.

In one implementation, at first, a user may use the client devices 104 to access the system 102 via the I/O interface 204. The user may register themselves using the I/O interface 204 in order to use the system 102. In one aspect, the user may access the I/O interface 204 of the system 102 for facilitating automated identification of the root causes for poor performance of an employee, the system 102 may employ the plurality of modules i.e. a receiving module 212, a root cause mining module 214 and a suggestion analysis module 216. The detailed working of the plurality of modules is described below.

Further, referring to FIG. 2, the system 102 for automated root cause identification for poor performance of an employee is disclosed. In one aspect, the receiving module 212 receives one or more self-comments of an employee with respect to his/her performance, one or more supervisor comments for the performance of the employee and root cause pattern data are received. In one example, the root cause pattern data may reside in a root cause repository 220. The root cause repository 220 refers to a 3-tuple data source comprising Tuple <Root Cause, Pattern for the Root Cause and Type of the Pattern for the root cause>. The exemplary patterns for identifying the root causes are shown below in Table 1. The patterns may be regular expression based patterns. In one embodiment, one root cause for poor performance of an employee has one or more patterns. In one embodiment, the root cause repository 220 also contains one or more actions specific to each root cause to be identified in order to improve the performance of the employee. The sample entries of the root causes (labels), patterns of the root causes and type of the pattern in the root cause repository 220 is displayed in Table 1.

TABLE 1

| | | Is Type of |
|---|---|---|
| Root Cause | | Pattern |
| (Label) | Pattern in terms of Regular Expression | Negative? |
| CODE_ | ((software\|code\|coding\|programs?\|components?\| | No |
| QUALITY | modules?)\W*(quality\|standards?\|reviews?)\| | |
| | (quality\|standards?\|reviews?) of | |
| | (code\|coding\|software\|programs?\|components?\| | |
| | modules?)\|patch(es)?\|fix(es)?) | |
| CODE_ | (defects?\|bugs?\|rework\|errors?\|flaws?) | Yes |
| QUALITY | | |
| TIMESHEET | (time\W?sheets?\|timings?\|(office\|shifts?)\ | No |
| | W?timings?\|work\W*(hour\|hr)s?\|stay(ed\|ing)?) | |
| TIMESHEET | unplanned\W*lea(f\|ves?) | Yes |

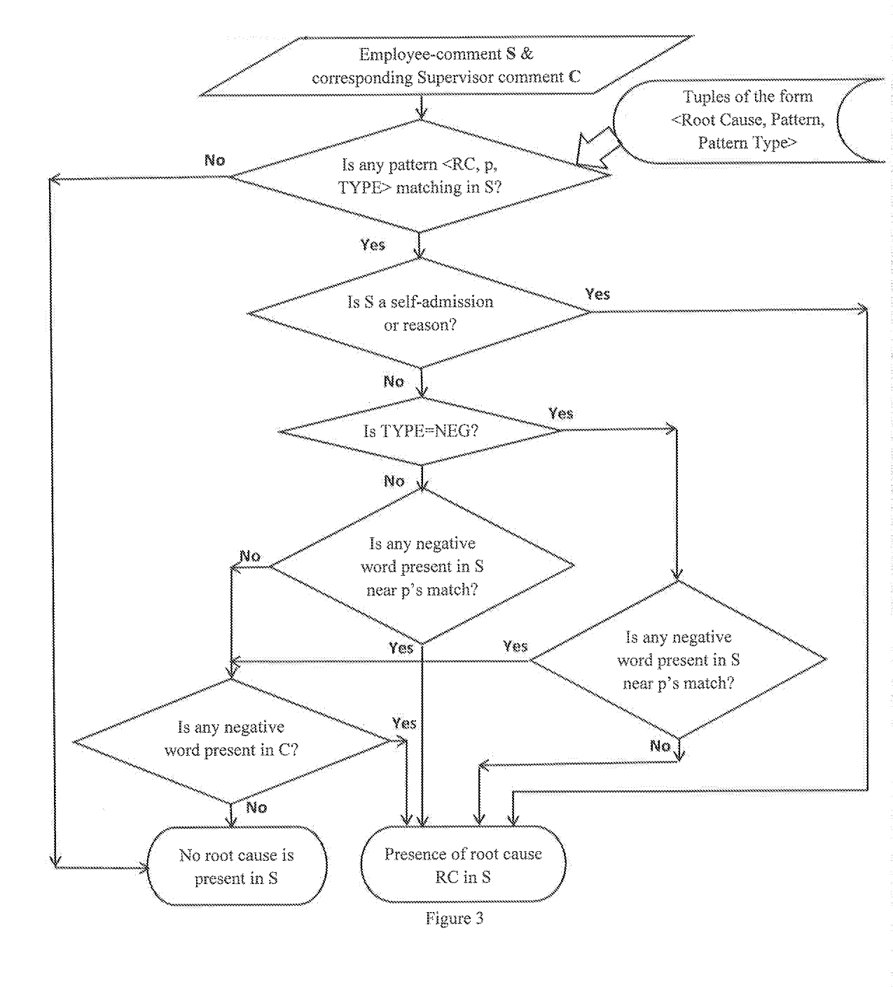

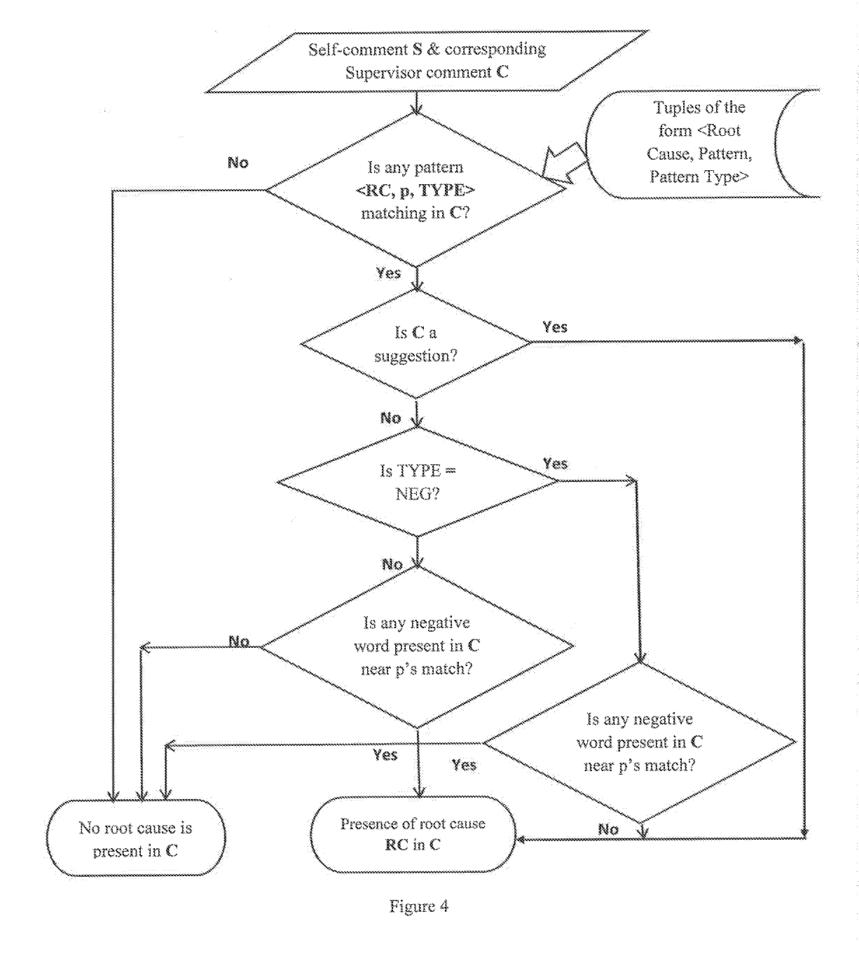

Upon receiving the one or more employee comments, supervisor comments and root cause pattern data, the root cause mining module 214 performs one or more steps to signify the presence of root causes in the one or more employee comments and supervisor comments. The determination of presence of the root causes in the one or more employee comments is illustrated in FIG. 3 and the determination of presence of the root causes in the one or more supervisor comments is illustrated in FIG. 4, in accordance with an embodiment of the present subject matter.

With reference to FIG. 3, the root cause mining module 214 performs matching between the patterns from the root cause pattern data and the one or more employee comments to obtain a first matched pattern. The first matched pattern refers to the pattern of the root cause repository ascertained to be present in the one or more employee comments i.e., the pattern matched with the employee comments. In one aspect, when no pattern from the root cause pattern data matches with the one or more employee comments, it signifies that no root cause is present in the one or more employee comments. In one aspect, when the first matched pattern is obtained, the root cause mining module 214 checks the one or more employee comments to determine whether the one or more employee comment includes a self-admission by the employee or a reason provided by the employee for his/her poor performance. In an aspect, if it is determined that the one or more employee comment includes the self-admission or the reason for the poor performance by the employee, it signifies that the root cause corresponding to the first matched pattern is in fact, the root cause present in the one or more employee comments.

In one aspect, when the root cause mining module 214 determines that the one or more employee comments do not include the self-admission or the reason, it further determines whether there is presence of a negative pattern type in the first matched pattern. The root cause mining module 214 further determines whether there is presence of a negative word within the one or more supervisor comments and near the first matched pattern within the one or more employee comments, for example, if at least one negative word is present within window of the four words occurring before and after the first matched pattern in the employee comments. In an embodiment, the number of words occurring before and after the first matched pattern within which the presence of negative word if determined may be defined by a user. In order to determine the presence of the negative pattern type in the first matched pattern, the third tuple in the root cause pattern data containing the type of each of the patterns of the root causes may be used. The presence of the negative word near the first matched pattern within the one or more employee comments indicates negative sentiment of the employee comments. Examples of negative words include: poor, bad, faulty, deficient and the like. Examples of a type of pattern and a sentiment in one or more employee comments in accordance with Table 1 is shown in Table 2:

TABLE 2

| Employee Comments | Type of pattern and the Sentiment |
|---|---|
| poor code quality reported in | Positive Pattern match with |
| sonar | negative sentiment |
| there are several bugs in delivery, | Negative Pattern match with |
| | absence of negative sentiment. |

In one embodiment, if either there is a presence of the negative pattern type in the first matched pattern data or there is presence of the negative word near the first matched pattern within the one or more employee comments, it signifies the presence of the root cause corresponding to the first matched pattern in the one or more employee comments. In other words, the presence of a root cause mentioned in the one or more employee comments is identified if either the type of first matched pattern is negative and no negative word is determined in the employee comment near the first matched pattern or if the type of first matched pattern is not negative and a negative word is determined in the employee comment near the first matched pattern. The root cause is identified from the root cause label present in the root cause repository 220 corresponding to the pattern matched in the one or more employee comments which resulted in the first matched pattern.

In another embodiment, if the root cause mining module 214 determines that each of the negative pattern type is present in the first matched pattern, and the negative word is present in the employee comments near the first matched pattern within the employee comments, and the negative word is present in the one or more supervisor comments, it signifies the presence of the root cause corresponding to the first matched pattern in the one or more employee comments.

In another embodiment, if the root cause mining module 214 determines that neither the negative pattern type is present in the first matched pattern, and nor the negative word is present near the first matched pattern within the employee comments, but a negative word is present in the one or more supervisor comments, it signifies the presence of the root cause in the one or more employee comments.

In another embodiment, if the root cause module 214 determines that a negative type is present in the first matched pattern and that a negative word is present near the first matched pattern in the employee comments but the negative word is absent in the one or more supervisor comments, it signifies that no root cause is present in the one or more employee comments.

In another embodiment, if the root cause module 214 determines the absence of each of the negative type in the first matched pattern, and the negative word near the first matched pattern in the one or more employee comments and the negative word in the supervisor comments, it signifies that no root cause is present in the one or more employee comments.

With reference to FIG. 4, the root cause mining module 214 performs matching between the patterns from the root cause pattern data and the one or more supervisor comments to obtain a second matched pattern. In one aspect, when no pattern from the root cause pattern data matches with the one or more supervisor comments, it signifies that no root cause is present in the one or more supervisor comments.

In one aspect, where the second matched pattern is obtained, it is then determined whether the one or more supervisor comments include at least one suggestion to improve the performance of the employee in the identified second matched pattern. The root cause module 214 includes a suggestion analysis module 216 to determine a suggestion from the one or more supervisor comments.

In one aspect, in order to perform the determination of the at least one suggestion from the one or more supervisor comments, the suggestion analysis module 216 employs two regular expression based patterns. The suggestion analysis module 216 runs a first pattern on the plain text sentence of the employee comments. The first pattern match identifies the specific words or bigrams indicating one or more suggestions present in the supervisor comments. In one example, the first text pattern to be matched with the plain text sentence is shown below:

\b(recommend(ed|ing)?|suggest(ion)?|advice|advise(d)?|improv
e|expect(ed|ing)?|enhance|upgrade|ensure|require(d)|aim|foc
us|improvise|practice|would be|could be|should be|please
see|be (better|good|best) up\W?to\W?date|implement|make
sure|needs? to|try to)\b~~~~~~~~~~~~first pattern

Examples of suggestions determined from the plain text pattern are: “Needs to get certified in core competency business objects” and “Please make sure to enhance your knowledge in Domain area too”.

In one embodiment, the suggestion analysis module 216 runs a second pattern on the part-of-speech (POS) tagged English sentences of the one or more supervisor comments. The POS tagged sentences of the one or more supervisor comments are obtained when for each word in the input plain text English sentence, an appropriate Part-of-Speech tag is identified by the suggestion analysis module 216 and the input plain text English sentence is converted to the format: word1/TAG1 word2/TAG2 . . . wordn/TAGn. The second pattern match identifies combination of specific words along with specific POS tags. It also identifies all the imperative sentences, which are generally suggestions present in the supervisor comments, in one example, the second POS tagged text pattern to be matched with the POS tagged sentence is:

(\b(((should|would|could|can|needs?|try)/[A-Z]+ [A-Za-
z]+/VB[A-Z]?)|(/VB (to|on|for|in))|(NNP?S? (is/VBZ )?
needed)|(look/VB[A-Z]? [A-Za-
z]+/JJ[RS]?)|((be|find)/VB[A-Z]? ([A-Za-z]+/(DT|JJ[RS]?)
)*+A-Za-z]-4-/NNP?S?)|((needs?|try)/[A-Z]+ (([a-zA-Z0-9\.\-
&]+?/JJ[ ])?([a-zA-Z0-9\.\-&]+?/NN(S|P|PS)?[ ])*(([a-zA-
Z0-9\.\-&]+?)/NN(S|P|PS)?))))\b|(\hat{ }|, |\. |/CC )([A-Za-
z]+/RB(S|R)? )?((?!agree|appreciate)[A-Za-z]+)/VB[
]((?!\bup/).)*$|\b(scope|chances?|room|area)/[A-Z]+
(for|of)/[A-Z]+ ((further|more|good)/[A-Z]+
)?improvements?/[A-Z]+ ([A-Za-z]+/RB(S|R)? )?[A-Za-
z]+/(IN|WRB) [A-Za-z]|(\hat{ }|, |\. |/CC
)(needs?|hope|work|plan|understand|learn|mentor|groom|sha
re|train|attend|conduct)/|(\bplease|pl[sz])/[A-Z]+ [A-Za-
z]+/|\byou/PRP to/TO [A-Za-z]+/VB[
]|\bshould/|\b(have|has)/[A-Z]+ to/TO [A-Za-
z]+/|\b(can|could|would|try|needs?)/[A-Z]+ [A-Za-
z]+/RB(S|R)? [A-Za-z]+/VB[ ]|\bto/TO be/[A-Z]+ [A-Za-
z]+/VB[ND]|\blooking/[A-Z]+ for(ward)?/[A-Z]+) ~~~~~
second pattern

Examples of suggestions determined from the POS tagged sentence with the pattern match shown in italics are:
1. He has to work hard by getting involved in different domains areas which will help him in future.
   He/PRP has/VBZ to/TO work/VB hard/RB by/IN getting/VBG involved/VBN in/IN different/JJ domains/NNS areas/NNS which/WDT will/MD help/VB him/PRP in/IN future/NN ./.
2. Also he should conduct KSS for his junior team mates related to current vulnerability.
   Also/RB he/PRP should/MD conduct/VB KSS/NNP for/IN his/PRP$ junior/JJ team/NN mates/NNS related/VBN to/TO current/JJ vulnerability/NN ./.

The first and the second patterns are designed in a fashion such that the patterns can identify a maximum number of keywords and/or a combination of keywords along with POS tags denoting presence of one or more suggestions in the one or more supervisor comments and thus an improved accuracy in terms of identifying the suggestions from a given set of comments with precision is achieved.

In an aspect, if the suggestion analysis module 216 determines that the one or more supervisor comment include the at least one suggestion to improve the performance of an employee, it signifies that the root cause corresponding to the second matched pattern is in fact, the root cause present in the one or more supervisor comments.

In one aspect, when the root cause mining module 214 determines that the one or more employee comments do not include the at least one suggestion, root cause mining module 214 further determines whether there is presence of a negative type in the second matched pattern. In order to determine the presence of negative type in the second matched pattern, the third tuple in the root cause pattern data containing the type of the pattern is used. The root cause mining module 214 further determines whether there is presence of a negative word near the second matched pattern within the one or more supervisor comments. The presence of a negative word near the second matched pattern within the supervisor comments indicates the negative sentiment of the supervisor comments. Examples of negative words include: poor, bad, faulty, deficient and the like.

In one embodiment, if either there is a presence of a negative type in the second matched pattern or there is presence of a negative word near the second matched pattern within the one or more supervisor comments, it signifies the presence of a root cause corresponding to the second matched pattern in the one or more supervisor comments. In other words, the presence of a root cause mentioned in the supervisor comment is identified if either the type of second matched pattern is negative and no negative word is determined in the supervisor comment near the second matched pattern or if the type of second matched pattern is not negative and a negative word is determined in the supervisor comment near the second matched pattern. The root cause present is identified from the root cause label present in the root cause repository 220 corresponding to the pattern matched in the one or more supervisor comments which resulted in the second matched pattern. An example of supervisor comment with a pattern match in accordance with table 1 and with presence of a suggestion is as follows: Example: thorough code review is required, should work on delivering quality and defect free deliverables.

In another embodiment, when the root cause mining module 214 determines that no negative pattern type is present in the second matched pattern, and that no negative word is present in the supervisor comments near the second matched pattern within the supervisor comments, it signifies that no root cause of poor performance of the employee is present in the one or more supervisor comments.

In another embodiment, when the root cause mining module 214 determines the presence of both the negative pattern type in the second matched pattern, and the negative word near the second matched pattern within the supervisor comments, it signifies that no root cause of poor performance of the employee is present in the one or more supervisor comments.

Once the root causes are identified from the employee comments and supervisor comments, the root cause mining module 214 then results an output where each employee's record is associated with the set of root causes identified.

In one embodiment, the root cause mining module 214 then performs mapping of the root causes identified by the root cause mining module with the one or more actions for each of the root causes stored in the root cause repository 220. Further, the root cause mining module 214 recommends one or more actions based on the root causes so identified and suggestions determined from the one or more supervisor comments. In one embodiment, the root cause mining module 214 recommends one or more actions based on the mapping of root causes to the actions specific to those root causes in the root cause repository and the one or more suggestions determined from the one or more supervisor comments. The root cause mining module 214 recommends actions to be performed both at the employee level and unit/organization level in order to improve the performance of the workforce in the unit/organization.

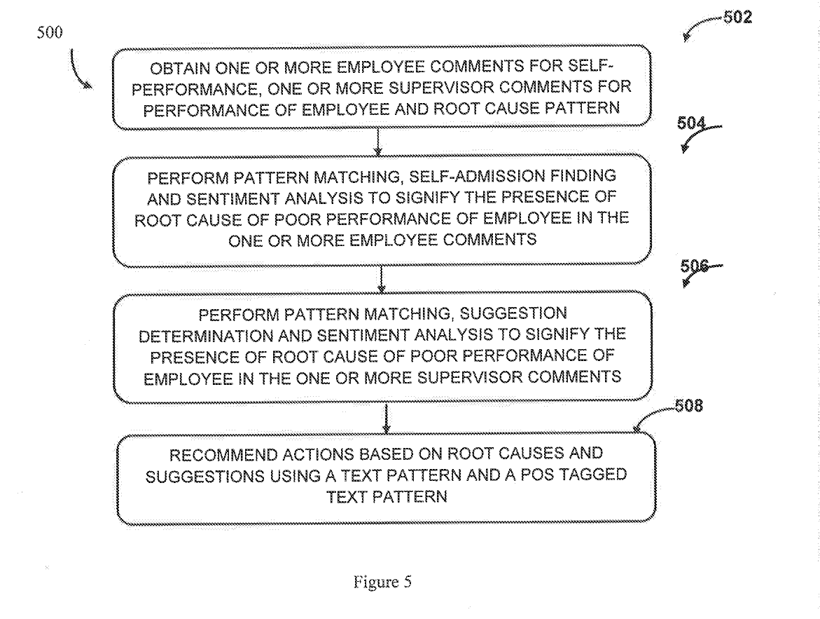

Referring now to FIG. 5, a method 500 for performing processor-implemented method steps for automated identification of root cause for poor performance of an employee is shown, in accordance with an embodiment of the present disclosure. The method 500 may be described in the general context of computer executable instructions. Generally, computer executable instructions can include routines, programs, objects, components, data structures, procedures, modules, functions, etc., that perform particular functions or implement particular abstract data types. The method 500 may be practiced in a distributed computing environment where functions are performed by remote processing devices that are linked through a communications network. In a distributed computing environment, computer executable instructions may be located in both local and remote computer storage media, including memory storage devices.

The order in which the method 500 is described is not intended to be construed as a limitation, and any number of the described method blocks can be combined in any order to implement the method 500 or alternate methods. Additionally, individual blocks may be deleted from the method 500 without departing from the spirit and scope of the disclosure described herein. Furthermore, the method can be implemented in any suitable hardware, software, firmware, or combination thereof. However, for ease of explanation, in the embodiments described below, the method 500 may be considered to be implemented in the above described in the system 102.

At block 502, one or more employee comments for self-performance and corresponding one or more supervisor comments for the performance of an employee may be received. In one embodiment, the one or more employee comments for self-performance and corresponding one or more supervisor comments for the performance of the employee may be received. The receiving module 212 may also receive root cause pattern data from a root cause pattern repository 220. The root cause repository 220 refers to a 3-tuple data source Tuple <Root Cause, Pattern for the Root Cause and Sentiment of the Pattern for the root cause>.

At block 504, the root causes present in the one or more employee comments are identified using first matching the root cause pattern data from the repository with the one or more employee comments to obtain a first matched pattern. If however, there is no pattern match, it signifies no root cause for employee's poor performance is present in the employee comments. In case of a pattern match, if the first matched pattern is determined to include a self-admission or a reason by the employee for poor performance, it signifies the presence of a root cause in the root cause repository 220 corresponding to the identified pattern to be present in the one or more supervisor comments. In case, the first matched pattern is determined not to be the self-admission or the reason then the presence of a negative pattern type in the first matched pattern, the presence of a negative word near the first matched pattern in the one or more employee comments and the presence of a negative word in the supervisor comment are determined. The presence of a root cause mentioned in the employee comment is then signified if either the negative pattern type is present in the first matched pattern type but no negative word is determined in the employee comment near the first matched pattern or if no negative pattern type is present in the first matched pattern type but a negative word is determined in the supervisor comment near the second matched pattern. The presence of a root cause mentioned in the employee comment is also identified in case the negative word is determined to be present in the one or more supervisor comments when either a) the negative pattern type is present in the first matched pattern and the negative word in the employee comments is present near the first matched pattern, or b) no negative pattern type is present in the first matched pattern and no negative word is present in the employee comments near the first matched pattern.

At block 506, the root causes present in the one or more supervisor comments are identified by first matching the root cause pattern data from the repository 220 with the one or more supervisor comments to obtain a second matched pattern. If however, there is no pattern match, it signifies no root cause for employee's poor performance is present in the supervisor comments. In case of a pattern match, if the second matched pattern is determined to include at least one suggestion, it signifies the presence of a root cause from the root cause repository 220 corresponding to the identified pattern i.e. the second matched pattern in the one or more supervisor comments. In case, the second matched pattern is determined to not include the at least one suggestion then the presence of the negative pattern type in the second matched pattern and the presence of a negative word near the second matched pattern in the supervisor comment is determined. The presence of a root cause mentioned in the supervisor comment is then signified if either the negative pattern type is determined to be present in the second matched pattern but no negative word is determined to be present in the supervisor comment near the second matched pattern or if no negative pattern type is determined to be present in the second matched pattern but a negative word is determined to be present near the second matched pattern in the one or more supervisor comments. The determination of a suggestion in the supervisor comments in block 506 is determined using a plain text pattern (first pattern as shown above) and a POS tagged text pattern (second pattern as shown above). The first text pattern identifies specific words or bigrams indicating at least one suggestion present in the one or more supervisor comments and the second POS tagged text pattern identifies at least one of a combination of one or more words along with one or more POS tags indicating the at least one suggestion and the one or more imperative sentences, which are generally suggestions in case of supervisor comment.

At block 508, actions based on the identified root causes of poor performance and the suggestions extracted are recommended. In one embodiment, actions based on the mapping of the identified root causes of poor performance with the specific actions for each of the root causes stored in the root cause repository and the at least one suggestion determined from the one or more supervisor comments are recommended.

Exemplary embodiments discussed above may provide certain advantages. Though not required to practice all aspects of the disclosure, these advantages may include those provided by the following features.

Some embodiments enable a system and a method to facilitate identification of a one or more root causes for poor performance of employees of an organization.

Some embodiments enable the system and the method to perform automated text mining, sentiment analysis and suggestion identification on large amount of varied and unstructured data comprising employee comments and supervisor comments.

Although implementations for methods and systems for performing automated root cause identification for poor performance of an employee have been described in language specific to structural features and/or methods, it is to be understood that the appended claims are not necessarily limited to the specific features or methods described. Rather the specific features and methods are disclosed as examples of implementations for facilitating the homogenized distribution of the airflow in the data center.

What is claimed is:

1. A method for automated root cause identification for poor performance of an employee, the method comprising processor implemented steps of:
receiving one or more employee comments for self-performance, one or more supervisor comments for performance of the employee, and root cause pattern data;
matching at least one pattern from the root cause pattern data with the one or more employee comments to obtain a first matched pattern to determine whether the one or more employee comments include a self-admission or a reason for the poor performance of the employee, to signify presence of a root cause in the one or more employee comments, wherein the at least one pattern is a regular expression based pattern and
when the one or more employee comments is not including the self-admission or the reason, determining presence of one of a negative pattern type in the first matched pattern and a negative word near the first matched pattern in the one or more employee comments to signify presence of the root cause in the one or more employee comments; and
determining presence of the negative word in the one or more supervisor comments;
matching at least one pattern from the root cause pattern data with the one or more supervisor comments to obtain a second matched pattern to determine whether the one or more supervisor comments include at least one suggestion, to signify presence of the root cause in the one or more supervisor comments, wherein the at least one pattern is a regular expression based pattern and
when the one or more supervisor comment is not including the at least one suggestion, determining presence of one of the negative pattern type in the second matched pattern and the negative word near the second matched pattern in the one or more supervisor comments, to signify presence of the root cause in the one or more supervisor comments, wherein the at least one suggestion from the one or more supervisor comments is determined by
matching a first text pattern with a plain text sentence in the one or more supervisor comments, wherein the first text pattern match identifies words or bigrams indicating the at least one suggestion present in the one or more supervisor comments, and
matching a second part-of-speech (POS) tagged text pattern with a POS-tagged sentence in the one or more supervisor comments, wherein the second POS tagged text pattern match identifies at least one of a combination of one or more words along with one or more POS tags indicating the at least one suggestion and imperative sentences; and
recommending one or more actions based on the root cause so identified and the at least one suggestion determined from the one or more supervisor comments.

2. The method of claim 1, wherein when no pattern from the root cause pattern data matches with the one or more employee comments or one or more supervisor comments, signifies that no root cause is present in the one or more employee comments or supervisor comments.

3. The method of claim 1, wherein the presence of each of the negative pattern type in the first matched pattern, the negative word comments near the first matched pattern in the employee, and the negative word in the one or more supervisor comments signifies the presence of the root cause in the one or more employee comments.

4. The method of claim 1, wherein the absence of both the negative pattern type in the first matched pattern and the negative word near the first matched pattern in the one or more employee comments and the presence of the negative word in the one or more supervisor comments signifies the presence of the root cause in the one or more employee comments.

5. The method of claim 1, wherein the presence of both the negative pattern type in the first matched pattern and the negative word near the first matched pattern in the employee comments and the absence of the negative word in the one or more supervisor comments signifies that no root cause is present in the one or more employee comments.

6. The method of claim 1, wherein the absence of each of the negative pattern type in the first matched pattern, the negative word in the one or more employee comments near the first matched pattern and the negative word in the supervisor comments signifies that no root cause is present in the one or more employee comments.

7. The method of claim 1, wherein either the presence of both the negative pattern type in the second matched pattern and the negative word in the one or more supervisor comments or the absence of both the negative pattern type in the second matched pattern and the negative word in the one or more supervisor comment signifies that no root cause is present in the one or more supervisor comments.

8. The method of claim 1, wherein the root cause pattern data is obtained from a root cause repository 220 which is a data source including three tuples namely root cause, pattern for the root cause and type of the pattern for the root cause.

9. The method of claim 1, wherein the first text pattern to be matched with the plain text sentence in the one or more supervisor comments include:
\b(recommend(ed|ing)?|suggest(ion)?|advice|advise(d)?|i
mprove|expect(ed|ing)?|enhance|upgrade|ensure|require(d
)?|aim|focsus|improvise|practice|would be|could
be|should be|please see|be
(better|good|best)|up\W?to\W?date|implement|make
sure|needs? to|try to)\b

10. The method of claim 1, wherein the second POS tagged text pattern to be matched with the POS tagged sentence in the one or more supervisor comments include:
(\b(((should|would|could|can|needs?|try)/[A-Z]+ [A-Za-
z]+/VB[A-Z]?)|(/VB (to|on|for|in))|(NNP?S? (is/VBZ )?
needed)|(look/VB[A-Z]? [A-Za-
z]+/JJ[RS]?)|((be|find)/VB[A-Z]? ([A-Za-
z]+/(DT|JJ[RS]?) )*[A-Za-z]+/NNP?S?)|((needs?|try)/[A-
Z]+ (([a-zA-z0-9\.\-&]+?/JJ[ ])?([a-zA-Z0-9\.\-
&]+?/NN(S|P|PS)?[ ])*(([a-zA-Z0-9\.\-
&]+?)/NN(S|P|PS)?))))\b|(\hat{ }|, |/. |/CC )([A-Za-
z]+/RB(S|R) )? )?((?!agree|appreciate)[A-Za-z]+)/VB[
]((?!\bup/).)*$|\b(scope|chances?|room|area)/[A-Z]+
(for|of)/[A-Z]+ ((further|more|good)/[A-Z]+
)?improvements?/[A-Z]+ ([A-Za-z]+/RB(S|R)? )?[A-Za-
z]+/(IN|WRB) [A-Za-z] |(\hat{ }|, |\. |/CC
)(needs?|hope|work|plan|understand|learn|mentor|groom|s
hare|train|attend|conduct)/|(\bplease|pl[sz])/[A-Z]+
[A-Za-z]+/|\byou/PRP to/TO [A-Za-z]+/VB[
]|\bshould/|\b(have|has)/[A-Z+ to/TO [A-Za-
z]+/|\b(can|could|would|try|needs?)/[A-Z]+ [A-Za-
z]+/RB(S|R)? [A-Za-z]+/VB[ ]|\bto/TO be/[A-Z]+ [A-Za-
z]+/VB[ND]|\blocking/[A-Z]+ for (ward)?/[A-Z+)

11. A system for automated root cause identification for poor performance of an employee, the system comprising:
a processor (202);
a memory (206) coupled to the processor (202), wherein the processor (202) is capable of executing a plurality of modules stored in the memory, and wherein the plurality of modules comprising:
a receiving module (212) configured to receive one or more employee comments for self-performance, one or more supervisor comments for performance of the employee, and root cause pattern data:
a root cause mining module (214) configured to
match at least one pattern from the root cause pattern data with the one or more employee comments to obtain a first matched pattern to determine whether the one or more employee comments include a self-admission or a reason for the poor performance of the employee, to signify presence of a root cause in the one or more employee comments, wherein the at least one pattern is a regular expression based pattern and
when the one or more employee comment is not including the self-admission or the reason, determine presence of one of a negative pattern type in the first matched pattern and a negative word near the first matched pattern present in the one or more employee comments to signify presence of the root cause in the one or more employee comments; and
determine presence of the negative word in the one or more supervisor comments; and
match at least one pattern from the root cause pattern data the one or more supervisor comments to obtain a second matched pattern to determine whether the one or more supervisor comments include at least one suggestion, to signify presence of the root cause in the one or more supervisor comments, wherein the at least one pattern is a regular expression based pattern and
when the one or more supervisor comments is not including the at least one suggestion, determine presence of one of the negative pattern type in the second matched pattern and the negative word near the second matched pattern in the one or more supervisor comments, to signify presence of the root cause in the one or more supervisor comments; wherein the root cause mining module (214) includes
a suggestion analysis module (216) configured to
determine the at least one suggestion from the one or more supervisor comments by
matching a first text pattern with a plain text sentence in the one or more supervisor comments, wherein the first pattern match identifies words or bigrams indicating the at least one suggestion present in the one or more supervisor comments, and
matching a second part-of-speech (POS) tagged text pattern with a POS-tagged sentence in the one or more supervisor comments, wherein the second POS tagged text pattern match identifies at least one of a combination of one or more words along with one or more POS tags indicating the at least one suggestion and imperative sentences; and
recommend one or more actions based on the root cause so identified and the at least one suggestion determined from the one or more supervisor comments.

12. The system of claim 10, wherein when no pattern from the root cause pattern data matches with the one or more employee comments or one or more supervisor comments, signifies that no root cause is present in the one or more employee comments or supervisor comments.

13. The system of claim 10, wherein the presence of each of the negative pattern type in the first matched pattern, the negative word in the one or more employee comments near the first matched pattern, and the negative word in the one or more supervisor comments signifies the presence of the root cause in the one or more employee comments.

14. The system of claim 10, wherein the absence of both the negative pattern type in the first matched pattern and the negative word near the first matched pattern in the one or more employee comments and the presence of the negative word in the one or more supervisor comments signifies the presence of the root cause in the one or more employee comments.

15. The system of claim 10, wherein the presence of both the negative pattern type in the first matched pattern and the negative word near the first matched pattern in the one or more employee comments and the absence of the negative word in the one or more supervisor comments signifies that no root cause is present in the one or more employee comments.

16. The system of claim 10, wherein the absence of each of the negative pattern type in the first matched pattern, the negative word in the one or more employee comments near the first matched pattern and the negative word in the supervisor comments signifies that no root cause is present in the one or more employee comments.

17. The system of claim 10, wherein either the presence of both the negative pattern type in the second matched pattern and the negative word in the one or more supervisor comments or the absence of both the negative pattern type in the second matched pattern and the negative word in the one or more supervisor comment signifies that no root cause is present in the one or more supervisor comments.

18. The system of claim 10, wherein the root cause pattern data is obtained from a root cause repository 220 which is a data source including three tuples namely root cause, pattern for the root cause and type of the pattern for the root cause.

19. The system of claim 10, wherein the first text pattern to be matched with the plain text sentence in the one or more supervisor comments include:
\b(recommend(ed|ing)?|suggest(ion)?|advice|advise(d)?|improv
e|expect(ed|ing)?|enhance|upgrade|ensure|require(d)?|aim|foc
sus|improvise|practice|would be|could be|should be|please
see|be (better|good|best)|up\W?to\W?date|implement|make
sure|needs? to|try to)\b

20. The system of claim 10, wherein the second POS tagged text pattern to be matched with the POS tagged sentence in the one or more supervisor comments include:
(\b(((should|would|could|can|needs?|try)/[A-Z]+ A-Za-
z]+/VB+A-Z?)|(/VB (to|on|for|in))|(NNP?S? (is/VBZ )?
needed)|(look/VB[A-Z]? [A-Za-
z]+/JJ[RS?)|((be|find)/VB[A-Z]? ([A-Za-
z]+/(DT|JJ[RS]?) )*(A-Za-z]+/NNP?S?)|((needs?|try)/[A-
Z]+ (([a-zA-Z0-9\.\-&]+?/JJ[ ])?(([a-zA-Z0-9\.\-
&]+?/NN(S|P|PS)?[ ])*(([a-zA-Z0-9\.\-
&]+?)/NN(S|P|PS)?))))\b|(\hat{ }|, |\. |/CC )([A-Za-
z]+/RB(S|R)? )?((?!agree|appreciate)[A-Za-z]+)/VB[
]((?!\bup/).)*$|\b(scope|chances?|room|area)/[A-Z]+
(for|of)/[A-Z]+ ((further|more|good)/[A-Z]+
)?improvements?/[A-Z]+ ([A-Za-z]+/RB(S|R)? )?[A-Za-
z]+/(IN|WRB) [A-Za-z]|(\hat{ }|, |\. |/CC
)(needs?|hope|work|plan|understand|learn|mentor|groom|s
hare|train|attend|conduct)/|(\bplease|pl[sz])./[A-Z]+
[A-Za-z]+/|\byou/PRP to/TO [A-Za-z]+/VB[
]|\bshould/|\b(have|has)/[A-Z]+ to/TO [A-Za-
z]+/|\b(can|could|would|try|needs?)/[A-Z]+ [A-Za-
z]+/RB(S|R)? [A-Za-z]/VB[ ]|\bto/TO be/[A-Z]+ A-Za-
z]+/VB[ND]|\blooking/[A-Z]+ for(ward)?/[A-Z]+)

21. A non-transitory computer program product having embodied thereon a program executable in a computing device for executing a method for implementing automated root cause identification for poor performance of an employee, the program comprising:
a program code for receiving one or more employee comments for self-performance, one or more supervisor comments for performance of the employee, and root cause pattern data;
a program code for
matching at least one pattern from the root cause pattern data with the one or more employee comments to obtain a first matched pattern to determine whether the one or more employee comments include a self-admission or a reason for the poor performance of the employee, to signify presence of a root cause in the one or more employee comments, wherein the at least one pattern is a regular expression based pattern and
when the one or more employee comments is not including the self-admission or the reason, determining presence of one of a negative pattern type in the first matched pattern or a negative word near the first matched pattern in the one or more employee comments to signify presence of the root cause in the one or more employee comments: and
determining presence of a negative word in the one or more supervisor's comment; and
matching at least one pattern from the root cause pattern data with the one or more supervisor comments to obtain a second matched pattern to determine whether the one or more supervisor comments include at least one suggestion, to further signify presence of the root cause in the one or more supervisor comments, wherein the at least one pattern is a regular expression based pattern and
when the one or more supervisor comments is not including the at least one suggestion, determining presence of one of the negative pattern type in the second matched pattern and the negative word near the second matched pattern in the one or more supervisor comments, to signify presence of the root cause in the one or more supervisor comments, wherein the at least one suggestion from the one or more supervisor comments is determined by
matching a first text pattern with a plain text sentence in the one or more supervisor comments, wherein the first text pattern match identifies words or bigrams indicating the at least one suggestion present in the one or more supervisor comments, and
matching a second part-of-speech (POS) tagged text pattern cond pattern with a POS-tagged sentence in the one or more supervisor comments, wherein the second POS tagged text pattern match identifies at least one of a combination of one or more words along with one or more POS tags indicating the at least one suggestion and imperative sentences; and
recommending one or more actions based on the root causes so identified and at least one suggestion determined from the one or more supervisor comments.
